(19) United States
(12) Patent Application Publication
(10) Pub. No.: US 2007/0212175 A1
(43) Pub. Date: Sep. 13, 2007

(54) Device and Method for Pneumatic Conveying of Bulk Materials in a Dense Flow Process

(76) Inventor: Patrik Ernst, Wurenlos (CH)

Correspondence Address: BACHMAN & LAPOINTE, P.C., 900 CHAPEL STREET, SUITE 1201, NEW HAVEN, CT, 06510, US

(21) Appl. No.: 11/632,812

(22) PCT Filed: Jul. 22, 2005
(86) PCT No.: PCT/EP05/08010

§ 371 Date: Jan. 18, 2007

(30) Foreign Application Priority Data
Aug. 5, 2004 (EP) 04405499.7

(51) Int. Cl. B65G 53/52; B65G 53/58

(52) U.S. Cl. 406/108

(57) ABSTRACT

A device for pneumatically conveying a free-flowing bulk material in a dense flow method, containing a cross-sectionally closed conveying line with a conveying channel, a compressed gas auxiliary line with a compressed gas channel, and gas passages which permit the passage of compressed gas and which serve to supply the conveying channel with a compressed gas from the compressed gas channel. A fluidizing device is assigned to the conveying line, and the fluidizing device contains a fluidizing body having a fluidizing gas channel and fluidized gas passage openings which permit the passage of fluidizing gas and which serve to supply a fluidizing gas from the fluidizing gas channel and into the conveying channel.

The present invention relates to a device and a method for pneumatic conveying of a bulk material in the dense flow process according to the preamble of the independent claims. The invention furthermore concerns the use of the device according to the invention.

The principle of pneumatic conveying is based on the known physical principle that flowing gases under particular conditions are able to carry and transport heavier solids. This principle is utilised technically in a targeted manner in pneumatic conveying. Transport frequently takes place through pipelines. The transport medium is always a gas flow, in particular an air flow, which is provoked by a pressure difference between the start and end of the pipe line.

Pneumatic conveying is used in widely varying branches of industry and with a multiplicity of bulk goods. Here we divide pneumatic conveying systems into suction and pressure conveying systems. Pressure conveying systems are divided further into light flow conveying, also called flying conveying, and dense flow conveying.

In light flow conveying, the goods to be transported are conveyed in relatively small quantities in the suspension or explosion method in a pneumatic flying conveying system using great quantities of air, by use of fan pressure, at high air speeds of approximately 20 to 40 m/s. The speed of the conveyor gas is here substantially greater than the falling speed of the material particles so that the bulk goods eddy and are transported continuously through the conveyor line as almost perfectly mixed gas/solids stream in stationary state. The pressure loss in the conveyor gas arises from the fluid friction of the conveyor gas, the specific gravity of the conveyed material and partly the solid/wall friction. This conveying state can be described as similar to a gas flow. So in light flow conveying, loads of around 1 to 10 are achieved. Load here means the mixing ratio of the number of “kg” of material transported per “kg” conveyor air. The pressure difference in light flow conveying is usually in the range of 0.5 to 1 bar but in exceptional cases can amount to up to 4 bar.

The disadvantage of this conveying technology is firstly the low transport volume in relation to the gas flow used and the high wear in the conveyor lines on transport of abrasive materials such as e.g. alumina. Furthermore, bulk goods in which the grain destruction is unacceptable, for example friable, crystalline or granular bulk goods, cannot be transported with sufficient care by means of flying conveying.

Different conditions exist in pneumatic dense flow conveying in which the gas speeds of approximately 1 to 15 m/s, in particular 2 to 10 m/s, lie in the range of or below the falling speed of the material particles. The name characterises the solids mass flow that is higher than in light flow conveying where the material transport resembles rather “sliding”. The term dense flow conveying includes amongst others skein-like conveying as a transitional type, ball conveying and the so-called plug conveying with a very high solids mass flow in relation to the conveying air quantity.

In dense flow conveying, loads of more than 10, in particular 30 and more are achieved. The upper load limit depending on goods transported can be around 150. In particular with plug conveying, loads of 30 to 120 are achieved. The pressure differences in dense flow conveying are over 1 bar, in particular in the range of 4 to 8 bar, where pressure differences of up to 16 bar are quite possible.

Due to the low gas speeds in the conveyor line, accumulations occur in the form of dunes and closed plugs. These plugs can completely fill the pipeline cross-section. In plug transport, due to the air flow, plugs of bulk goods therefore form recurrently, which are then broken down and accelerated.

The main advantage of this conveying mode in relation to flying conveying is the substantially reduced abrasion of the bulk goods and the reduced pipe wear and low energy costs because of the lower compression power.

The disadvantage of this method is that the bulk goods, due to the constant formation and destruction of plugs, moves through the conveyor line in a non-stationary manner, where pressure in the line because of a plug frequently rises until the plug is propelled on jerkily through the conveyor line. Because of the release of the pressurized gas volume before the plug, a high plug speed is achieved which can be above the gas speed and under some circumstances can lead to a shot-like forward movement of the plug.

In order to overcome the said disadvantages it has been considered to feed compressed gas into the conveyor line by way of parallel bypass lines. The gas flow, guided laterally out of the bypass line into the conveyor line, causes the break down of material compactions, countering the formation of dunes or plugs because of the eroding effect of the compressed gas flow. In addition, the positive pressure forming in front of the plug or material compaction is dissipated past the plug by way of the bypass line and returned to the transport channel after the plug and divided. Compactions and plugs are also continually eroded by way of the compressed gas flowing into the transport channel.

By this measure the transport capacity in the dense flow method can be increased and the wear reduced further. Furthermore, the additional compressed gas secondary line allows the (gentle) resumption of transport after a transport interruption with a full conveyor line. However, in the above method the transported material is also moved through the conveyor line in a non-stationary manner as material compactions still occur in the mass flow.

The object of the present invention is therefore to propose a device and a method for pneumatic conveying of a bulk material in the dense flow method which allows the transport of a bulk material in the dense flow method as far as possible without or with reduced plug formation and fewer material compactions.

This object is achieved by the characteristic features of the independent claims. Special embodiments of the invention are described by the dependent claims.

The device is characterised in that allocated to the conveyor line is a fluidising device and the fluidising device contains a fluidising body with a fluidising gas channel and fluidising gas passage means to feed a fluidising gas from the fluidising gas channel into the conveyor channel.

Conveyor lines which are closed in cross-section are lines that are closed against the free surrounding atmosphere and no direct air exchange can take place between the conveyor line and the surrounding atmosphere.

Bulk materials are in particular dust-like, powder, fine grained, granular, pellet-like or granulate bulk materials. The said bulk materials are preferably dry materials and comprise an accumulation of solid particles of for example round, spherical, plate-like, needle-like or angular shape. The size of the bulk material particles is preferably substantially uniform. The bulk materials which are conveyed by means of the device according to the invention can have grain sizes of up to 20 mm with a fines or dust proportion of e.g. >2%. The bulk materials particles preferably have an average grain size of ≦2 mm, in particular 0.04 to 1 mm.

The compressed gas secondary line or compressed gas channel is preferably arranged, or guided within, in particular in the upper cross-section half of the conveyor channel or conveyor line. The terms “upper” and “lower” are here used in the sense of the spatial arrangement in the gravity field. The compressed gas secondary line is preferably arranged in the apex area of the upper cross-section half of the conveyor channel. The compressed gas secondary line or compressed gas channel can however also be arranged outside the conveyor channel (on the top).

The compressed gas passage means suitably comprise a gas-permeable material described below which allows the escape of compressed gas from the compressed gas secondary line into the conveyor channel, generating a gas flow. The gas permeability can be achieved for example through micro-openings, pores, holes, slots or perforations in the gas passage body.

The gas-permeable material can for example be a sintered metal e.g. sintered bronze or sintered iron, or a sintered ceramic such as aluminium oxide. The porous material can also comprise a braided wire, a porous ceramic material, a perforated, slotted or holed material such as a sheet, plate, or tube of metal or plastic. Furthermore, the material can be a permporous plastic.

The gas-permeable material can furthermore be made of a textile flat structure e.g. fleece, weave, laid or braided material, mat, knitted material, needle-worked or worked material. The fibres which are processed into the textile flat structure can be organic fibres such as natural fibres or plastic fibres e.g. polyester fibres or inorganic fibres such as glass fibres or carbon (aramide) fibres, metal fibres or ceramic fibres such as aluminium oxide. Mixed fibres can also be used.

The compressed gas secondary line preferably contains gas passage openings in the form of holes or slots through which the compressed gas can flow from the compressed gas secondary line into the conveyor channel. The holes or slots can for example be arranged at intervals of 3 to 10 cm along the transport direction. The holes can for example have a diameter of 0.1 to 2 mm. The diameter of the passage openings is preferably less than the particle diameter of the transported material. Due to the special design of the gas passage openings, on emergence from the gas secondary line, the compressed gas can be given a direction component in the transport direction. Primarily the compressed gas however serves to break up and not to transport further the conveyed material.

The compressed gas secondary line can be guided completely or in sections parallel to the conveyor line. The compressed gas secondary line is particularly preferably a compressed gas pipe line, in particular a pipe line with annular cross-section. The inner (smallest) diameter of the conveyor line suitably corresponds to 2.5 to 60 times, preferably 3.5 to 40 times, in particular 4 to 30 times the inner (smallest) diameter of the compressed air secondary line.

The term “pipe” in the description below also includes lines with round or annular cross-section, in particular lines with polygonal, in particular rectangular or square cross-section, or a combination of round and polygonal cross-section. In principle the line cross-section can be structured arbitrarily.

The compressed gas secondary line can also be formed as a channel profile, on the open side of which is arranged the compressed gas passage means to form a closed duct connected with the channel profile.

The compressed gas secondary line is preferably introduced into the transport channel and connected with the conveyor line by way of suitable fixing means such as screwing, riveting, soldering, welding, clamping, gluing etc.

Furthermore, the compressed gas channel can also be an integral part of the conveyor line, in that for example the conveyor line is produced as one piece with a (smaller) compressed gas channel and a (larger) conveyor channel. The separating wall between the compressed gas channel and the conveyor channel here comprises or constitutes the gas passage means.

It is also possible for the compressed gas secondary line to contain several compressed gas channels which for example are formed by a multiplicity of parallel compressed gas pipes.

Air is preferably used as a compressed gas. To generate or prevent chemical reactions or for other reasons however, other gases or gas mixtures can be used e.g. an inert gas or N₂.

The compressed gas is generated by way of a compressed gas generation plant with which the compressed gas secondary line is connected by way of supply lines. The said plant preferably comprises one or more compressors which bring the compressed gas to the required pressure. The compressed gas generation plant can also contain one or more compressed gas accumulators.

The compressed gas secondary line can contain means such as obstacles, e.g. cross-section reducing devices or constrictions, to generate a pressure fall. Furthermore, the gas passage openings of the compressed gas secondary line can contain valves which are operated by way of a valve control as a function of the pressure differences between the compressed gas secondary line and the conveyor line. The pressure differences are here determined by way of pressure sensors.

The fluidising device contains a fluidising body with a fluidising gas channel. The fluidising gas channel is spatially delimited from the conveyor channel inter alia by way of the fluidising gas passage means. The fluidising body or fluidising gas channel is preferably arranged within the conveyor channel or conveyor line. The fluidising body is preferably arranged in the lower cross-section area of the conveyor channel, in particular in the base area of the lower cross-section surface. The fluidising body or fluidising gas channel can also be arranged outside the conveyor channel (on the floor side).

The fluidising device can be provided with horizontal components in the transport direction in all line sections. Furthermore, the fluidising device can be provided merely in sections at specific line sections, e.g. only at line sections with a positive gradient.

The fluidising body is preferably inserted into the fluidising channel and connected to the conveyor line by way of a suitable fixing means e.g. screwing, riveting, soldering, welding, clamping, gluing etc. The fluidising body is in particular connected to the conveyor line by way of the fluidising gas supply lines fixed to the conveyor lines by means of screw connections.

The compressed gas channel of the compressed gas secondary line and the fluidising gas channel of the fluidising device are preferably arranged along a common plane of gravity (E) which runs along the conveyor line and preferably intersects the apex point and the base point of the conveyor line. The said plane of gravity runs in the gravity direction.

The fluidising gas passage means are suitably made of a gas-permeable material which under formation of a gas flow and fluidising of the bulk material in the conveyor channel allows a (permanent) escape of the pressurised gas in the fluidising gas channel. The gas-permeability can be achieved for example by micro-openings, pores, holes, slots or perforations in the gas passage body.

Due to the design of the fluidising gas passage body, in particular the design of the fluidising gas passages, and/or the arrangement of the fluidising gas passage body, in particular the arrangement of the fluidising gas passages, it is ensured that the solid phase can not escape into the fluidising gas channel in any operating mode of the conveyor system. Thus, the size of the fluidising gas openings can be structured so that the transported material particles cannot penetrate through the openings into the fluid gas channel or even block the openings. Furthermore, the alignment of the fluidising gas passages can be such that the transported material particles can only penetrate through the openings into the fluidising gas channel by movement against gravity.

The fluidising gas body or fluidising gas passage means are preferably such that the fluidising gas is fed into the conveyor channel distributed as evenly as possible and thus ensures fluidising of the transported material over a broad area.

The gas-permeable material can e.g. be made of a sintered metal such as sintered bronze or sintered iron or a sintered ceramic material such as aluminium oxide. The porous material can also comprise a wire braid, a porous ceramic material, a holed or perforated or slotted material such as a sheet, a plate or a pipe of a metal or plastic.

The fluidising gas passage means can for example contain a wall of the fluidising gas channel fitted with holes or perforations. Furthermore, the material can be a permporous plastic.

The gas-permeable material can furthermore comprise a textile flat structure such as e.g. a fleece, weave, laid or braided fabric, mat, knitted fabric, needle-worked or worked fabric. The fibres which are processed into the textile flat structure can be organic fibres such as natural fibres, or plastic fibres e.g. polyester fibres, or inorganic fibres such as glass fibres or carbon (aramide) fibres, metal fibres or ceramic fibres such as aluminium oxide. Mixed fibres can also be used.

The fluidising device can contain deflection means to deflect the fluidising gas emerging through the fluidising gas passage means from the fluidising gas channel to the conveyor channel. The deflector means are suitably arranged such that the deflected fluidising gas has at least one direction component against the gravity acting on the bulk material particles i.e. a rising tendency.

The deflection means are furthermore preferably arranged such that these deflect the fluidising gas immediately after emergence from the fluidising gas channel and before this becomes effective at fluidisation.

In the use of deflection means the gas passages in the fluidising body are suitably aligned such that the fluidising gas flowing into the conveyor channel has a direction component pointing in the gravity direction i.e. a falling tendency. The fluidising gas here preferably flows obliquely sideways down out of the fluidising gas channel.

The deflection means preferably contain deflection elements with flat, concave or convex deflection surfaces. These can for example be deflection plates or sheets. The deflection means can for example be formed as (semi-) dish elements. Furthermore, the deflection elements can also be formed by the wall of the conveyor channel itself.

The fluidising gas is preferably guided into a multiplicity of fine thin gas streams emerging from the openings of the fluidising body onto the deflection means, wherein the deflection means are structured such that the gas flows undergo a deflection and preferably simultaneously a scattering so that the transported material is fluidised evenly over a broad area by the deflected and scattered gas streams. The scattering of the gas streams can be further promoted by the specific design of the deflecting surfaces, in particular by the application of roughness patterns.

The fluidising device comprises in a preferred embodiment a fluidising gas pipe formed as the fluidising gas channel. The fluidising gas passage means according to this embodiment contain hole openings or slots in the wall of the fluidising gas pipe. The openings preferably contain a direction component pointing in the gravity direction, where opposite the openings is arranged a deflection element, in particular a deflection element with concave deflection surface.

The diameter of the hole openings can be 0.04 to 2 mm. The distance between the individual openings can be 0.5 to 50 cm, in particular 2 to 20 cm. The diameter of the passage openings is preferably less than the diameter of the solid particles.

In a further embodiment of the invention the fluidising gas passage means comprise a gas-permeable, textile flat structure. The textile flat structure is preferably arranged such that the fluidising gas emerging from the fluidising gas channel into the conveyor channel has a direction component against the direction of gravity i.e. a rising tendency. The conveying gas preferably emerges substantially vertically into the conveyor channel through the textile flat structure.

The textile flat structure is preferably attached to an open channel profile by means of corresponding fixing means e.g. clamping, riveting, gluing etc. and with this forms a fluidising gas channel with a cross-section which is closed to the solid phase.

The textile flat structure particularly preferably forms a so called fluidising floor which stands at a right angle to said plane of gravity (E).

It is possible that the fluidising body contains several fluidising channels e.g. several parallel fluidising gas pipes.

The conveyor line of the device according to the invention in a preferred embodiment of the device comprises several conveyor line sections joined together i.e. mutually joined. Individual conveyor line sections can have lengths of a few metres e.g. from 1 to 18 m. Normally the length of a conveyor line section is around 6 m. Individual conveyor line sections are here formed preferably straight and rigid. Any gradient changes are preferably completed by way of separate bending section elements which are coupled to the line sections e.g. by way of couplings. The bending section elements are e.g. castings, in particular metal or plastic castings. They can enclose conveyor angles of more than 0° and less than 180°.

The conveyor line sections preferably form a butt joint at which these are coupled by means of coupling elements into a gas-tight line system. The conveyor line sections can however also be pushed together or connected together by other connection technologies i.e. welding, soldering, screwing, riveting, gluing. Combinations of different connection technologies are also possible.

The individual or all conveyor line sections each contain a fluidising body with a fluidising gas channel with one or more fluidising gas supply openings and fluidising gas passage means. The fluidising channel is preferably closed over the entire circumference i.e. in particular closed gas-tight at both ends. The fluidising bodies of the individual conveyor line sections are consequently preferably not connected together directly.

The fluidising body of a conveyor line section in a preferred embodiment of the invention does not extend beyond the end faces of the conveyor line section. The fluidising gas channel or fluidising body is preferably the same length as or shorter than the conveyor line section so the conveyor line sections can easily be joined end to end.

One, two or more fluidising gas supply lines opening in the fluidising gas channel can be allocated to each fluidising body of a conveyor line section. If the fluidising body is arranged in the conveyor channel, the fluidising gas supply lines pass through the walls of the conveyor line.

The fluidising gas supply lines are connected to a compressed gas generating plant by way of a fluidising gas line system. This plant preferably comprises one or more compressors which bring the fluidising gas to the desired pressure level. Furthermore, allocated to the compressed gas generating plant can be one or more pressure accumulators which temporarily store the compressed gas which is generated.

The fluidising bodies of several or all conveyor line sections can be connected together by way of a common fluidising gas supply line system and subject to central control. Control means such as pressure regulator valves or similar means with associated control can ensure that individual fluidising bodies can be controlled independently of each other and supplied with fluidising gas independently of each other. Furthermore, means can be provided which allow individual control of the gas pressure for the individual fluidising bodies.

The fluidising bodies of several or all conveyor line sections are preferably supplied by way of a common compressed gas generation plant. They can however also be supplied individually or in groups by way of several compressed gas generating plants working independently of each other.

If the conveyor line has a severe bend directed upwards against gravity, in particular a bend of around 900, in the bend section can be provided an additional fluidising device which fluidises the transported material on entry into the upward-pointing line section. Normally the upward-pointing line section runs vertically. The fluidising device for this is arranged in the base or foot area of the bend section and contains a fluidising gas chamber, fluidising gas passage means and fluidising gas supply means. The fluidising gas passage means are preferably formed by a textile flat structure. However, other fluidising gas passage means are conceivable as already described above. The fluidising gas passage means of the fluidising device in the line section need not be the same as those in the bend section.

The textile flat structure separates the fluidising gas chamber from the conveyor channel and forms a so-called fluidising floor. The fluidising device is preferably connected detachably and gas-tight to an opening on the floor side in the bend section element. The connection can take place by way of several ring flanges screwed together.

The bend section can be a casting, in particular a metal or plastic casting, which contains a floor opening for flange attachment of the fluidising device described above. The conveyor line sections are for example attached to the inlet or outlet opening of the bend section by means of couplings.

In principle the fluidising device which is described above in the bend section can be provided independently of the existence of a fluidising device or compressed gas secondary line in the line section of the conveyor system. The bend section element described here with fluidising device should therefore be regarded as an independent object of the invention. This is used in particular in a dense flow conveyor system according to the definition in the description introduction.

Air is preferably used as a fluidising gas. To generate or prevent chemical reactions or for other reasons however different gases or gas mixtures can be used e.g. an inert gas or N₂.

As the compressed gas and fluidising gas combine with the conveyor gas in the transport channel, these gases are preferably identical with regard to composition. The compressed gas, transport gas and fluidising gas can therefore come from the same compressed gas generator (e.g. compressor) or compressed gas accumulator. This means that also the compression and conveyor gas required in the dense flow process to build up the pressure in the sender, see below, can come from the same compressed gas generator or accumulator and hence from the same compressed gas supply network.

The compressed gas which is used for the above purposes can, as already stated, be temporarily stored in one or more pressure accumulators which are mutually dependent or independent, fitted with known control devices. The compressed gas can be supplied by way of known pressure control valves, switch valves and adjustment valves from the compressed gas generator or compressed gas accumulator to its destination i.e. the sender, fluidising gas channel, compressed air secondary line or conveyor line. For this the compressed gas is suitably brought to the corresponding pressure level by way of the pressure control valve and supplied by way of separate supply lines to the conveyor channel or sender, fluidising gas channel and compressed air secondary line.

Because of the high pressure fall along the conveyor line due to the high solids concentration, pneumatic dense flow conveyors—as already explained—contain a pressure vessel, also called a sender, for input of the solids into the conveyor line. Allocated to the sender are furthermore means for even or cyclic supply of a compressed gas to build up pressure in the pressure vessel. The means comprise for example one or more compressors, a compressed gas line and control valves and in some cases a compressed gas accumulator. The dense flow conveyor system is here a closed system with controlled pressure conditions within a pipe system.

The fill limit of the pressure vessel can be ensured by a limit switch. With a pneumatic valve control, the loads in the pressure vessel can be set precisely. The fill limit of the pressure vessel can be ensured by metering or weighing. The form of the pressure vessel ensures that the bulk materials are pressed into the conveyor line under control, evenly and completely.

Arranged before the pressure vessel for example is a storage container or a supply line. Directly or indirectly connected to the pressure vessel is the conveyor line. In some cases after the pressure vessel can be provided means for even or cyclic supply of an additional conveyor gas into the conveyor line, which should not be confused with the supply of compressed gas from the compressed gas secondary line. The conveyor line ends in a consumer which for example can be a processing device or a storage container.

The conveyor line, compressed gas secondary line and the fluidising body can be made of a metal, in particular steel or aluminium, or a pressure-resistant plastic. If the said lines or channels are formed from a pipe, this can be produced by means of the extrusion process or as a rolled product. In the latter case the pipes have weld seams or solder points. If the fluidising body or compressed gas secondary line has a channel profile, this can also be produced by means of the extrusion process or from a rolled product.

The conveyor line or pipe is preferably formed annular in cross-section. As a result the individual conveyor pipe sections can be coupled together gas-tight with simple couplings into one conveyor line. In principle the line cross-section can however be arbitrary.

To operate the dense flow conveyor system, from a storage container or by way of a supply line, transported material is fed into the pressure vessel. The sender content can be monitored by way of level sensors. Then the transport gas is fed into the pressure vessel forming a particular gas-transported material mixing ratio. The pressure in the sender can be monitored by way of pressure sensors. Preferably air is used as the conveyor gas. To generate or prevent chemical reactions or for other reasons however, other gases or gas mixtures can be used e.g. inert gas or N₂.

Then the transported material is transferred from the sender under pressure into the conveyor line attached thereto. By way of a sensor-guided control device, it is ensured that the conveyed product is pressed into the conveyor line under control, evenly and completely.

By way of the compressed gas secondary line, to loosen the transported material and prevent or reduce material compactions, compressed gas is fed into the upper cross-section area of the transport channel. The compressed gas can be fed into the transport channel of the conveyor line system temporarily or permanently, and throughout or in sections, depending on local conveying conditions. Furthermore, the compressed gas can be transported evenly, in pulses or with changing intensity. The compressed gas can be supplied over the entire conveyor line or locally or in sections. This means that the compressed gas is blown in merely at places at which the bulk material has compacted to form dunes or plugs. In the latter design a corresponding control of the compressed gas supply by way of valves is necessary. The corresponding control signals for this can be determined from pressure measurements taken by way of pressure sensors in the conveyor channel.

The transported material which is loosened by the introduction of compressed gas is fluidised by feeding fluidising gas into the lower i.e. the floor area of the conveyor channel. Fluidising means that the bulk materials are loosened by the introduced fluidising gas and transformed into a gas-solids mixture, in that the particles are raised against gravity by the fluidising gas flowing from the floor and transformed into a suspended state, wherein an air layer is generated between the particles so that the internal friction of the transported material diminishes substantially. The gas-solids mixtures behave similarly to a fluid with regard to flow behaviour under pressure differences within the pipeline. The fluidised transported goods now flow in the same way as a fluid in the transport direction to the consumer under the permanent conveyor pressure.

The fluidising gas can be fed into the conveyor channel of the conveyor line system temporarily or permanently, and throughout or in sections, depending on local conveying conditions. Furthermore, the feed of fluidising gas into the individual line sections can also change with the changing transport conditions during the conveying process. The fluidising gas can be fed evenly or with changing intensity over the entire conveying duration. As the fluidising bodies of the individual conveyor line sections are preferably not directly connected together, by way of suitable (pressure) sensors and control means the fluidising conditions as stated above can be maintained differently over the individual conveyor line sections.

The driving force in the dense flow method according to the invention, in contrast with flying conveying, is to a significant extent the static pressure which is built up in the pressure vessel and in some cases in the conveyor line by way of the compressed gas supply line. The drive for transporting the bulked products substantially results from the pressure gradients within the conveyor line. Compression of the gas in the conveyor line is therefore of great importance in dense flow conveying, in contrast to flying conveying. The supplies of compressed gas by way of the compressed gas secondary line and fluidising gas in contrast serve preferably exclusively to loosen and fluidise the conveyed goods and not—or at most to a very slight extent—as a drive for transport of the conveyed goods.

The effect of a positive pressure on the consumer can be avoided by measures which are inherent in the device or method in that the pressure of the conveyor flow, e.g. up to the pressure predominating at the entrance to the consumer, normally atmospheric pressure, is reduced.

In contrast to the known conveying channel, also called an air slide or fluidising channel, which also uses the principle of fluidisation, the present device is not necessarily suitable for a geodetic gradient.

The present device and method correspond rather to a type of combination of dense flow conveying and flow conveying. The gas speed in the transport direction is here preferably in the area of or below the sink speed of the particles.

The gas pressure in the fluidising gas channel for this is higher than that in the conveying channel. The same also applies to the gas pressure in the pressurised gas secondary line which is generally higher than that in the transport channel. If the transport channel is blocked—which should not occur in sustained operation but at most on start-up of the conveying process with a filled or newly filled conveyor line—the gas pressure building up behind the plug can exceed the gas pressure in the compressed gas secondary line so that the conveyor gas flows into the compressed gas secondary line and bypasses the plug in this way.

The gas pressure in the fluidising gas channel can be greater than, equal to or less than that in the compressed gas secondary line. Preferably, the gas pressure in the fluidising gas channel is 0.1 to 2 bar higher than that in the compressed gas secondary line.

The conveyor speed is preferably 15 m/s or less, in particular 10 m/s or less and advantageously 5 m/s or less, preferably 0.1 m/s or higher, in particular 1 m/s or higher, advantageously 2 m/s or higher. The pressure differences used between the sender and consumer are preferably above 1 bar, in particular above 2 bar, advantageously above 4 bar and preferably below 20 bar, in particular below 10 bar and advantageously below 8 bar.

The loading according to the present invention is preferably above 10, in particular above 30, advantageously above 40 and preferably below 200, in particular below 160, advantageously below 80.

With the device according to the invention the transported goods can be transported by way of horizontal, sloping or vertical sections downwards and upwards with favourable energy use. With the device according to the invention, in particular gradients of more than 0 to 200 can easily be overcome. Furthermore, as described above, vertical gradients can be overcome with no problem with the use of a fluidising unit in the pipe bend.

The conveyor lines can extend easily to a few kilometres, for example more than 0 to 5 km. The internal diameter of the conveyor line can range over a broad spectrum and depends on the bulk material and the conveying capacities required. Thus, this can for example amount to 30 to 750 mm, in particular 50 to 500 mm. The compressed gas secondary line and the fluidising device are dimensioned according to the size of the conveyor channel.

The conveying process can, without completely emptying the conveying channel, be ended by reducing the gas pressure. The material remaining in the conveyor lines settles under compaction. The lines therefore remain partially filled, so that immediately after resumption of the conveying process the consumer is supplied with conveyed product without first requiring a time-consuming filling of the conveyor line.

On resumption of the conveying process the compacted bulk goods are loosened in advance by the compressed gas flowing from the compressed gas secondary line into the conveyor channel. The loosened transported material can consequently be fluidised by feeding in fluidisation gas so that immediately after start-up of the plant, conveying of the bulked materials can be initiated without further measures. Evacuating the conveyor lines, as required in other pneumatic conveyor systems, is not necessary with the present apparatus according to the invention. This does however require that a compressed gas secondary line be allocated to the conveyor line as described since the transported material deposited locally in the shut-down conveyor system, under certain circumstances in great quantities, cannot be loosened or fluidised particularly well or at all merely by feeding in a fluidising gas.

The device and the method preferably serve to convey bulk bauxite and aluminium oxide or alumina in the aluminium industry. This can for example be the transfer of the alumina from transport means such as ships or vehicles to a storage device such as silos or bunkers, or from a storage device to an electrolysis hall or to feed the electrolysis cells. The said alumina can contain additives such as fluoride or flux agent.

Furthermore the device and method are used in:
coal-fired power stations to transport pulverised coal or ash;
the chemical industry to transport plastic powder or granulate and other bulk materials;
the foodstuffs industry e.g. to transport bulky foodstuffs such as salt, sugar, cocoa powder, flour, milk powder or fine-grained seeds;
the cement or building industry to transport e.g. gypsum, cement, brick dust and additives, sand, quartz, crushed coal or chalk.

The device according to the invention or the method are used e.g. to transport a bulk material between a transport means such as a ship, rail or road vehicle and a storage device such as a (storage) silo or bunker or vice versa. Furthermore, to transport a bulk material between two storage devices or between two transport means. Furthermore, the invention is used to transport a bulk material between a storage device or a transport means and a consumer such as a processing device (e.g. electrolysis furnace).

The invention is described in more detail below with reference to the enclosed drawings. These show:

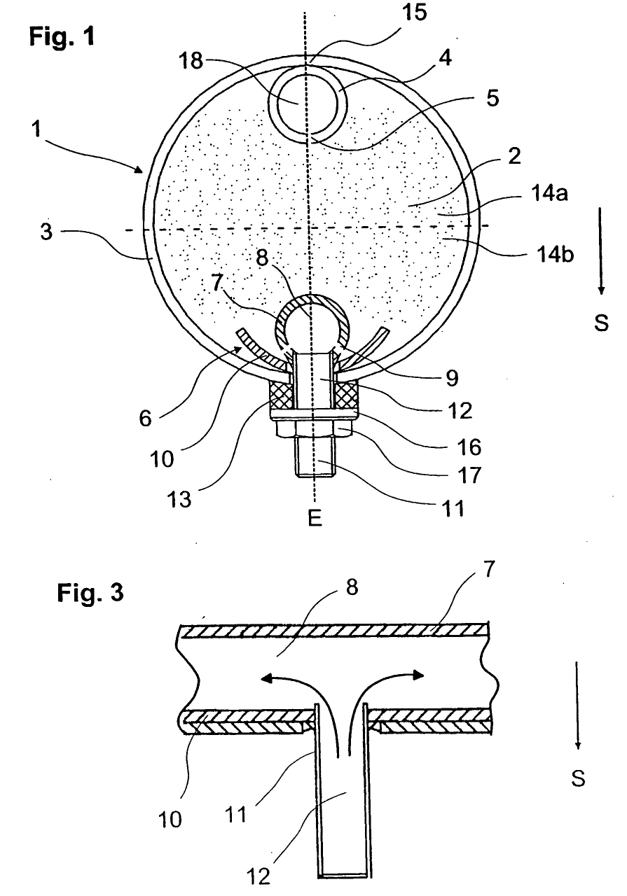

FIG. 1: a cross-section through the conveyor line of a device according to the invention in a first embodiment;

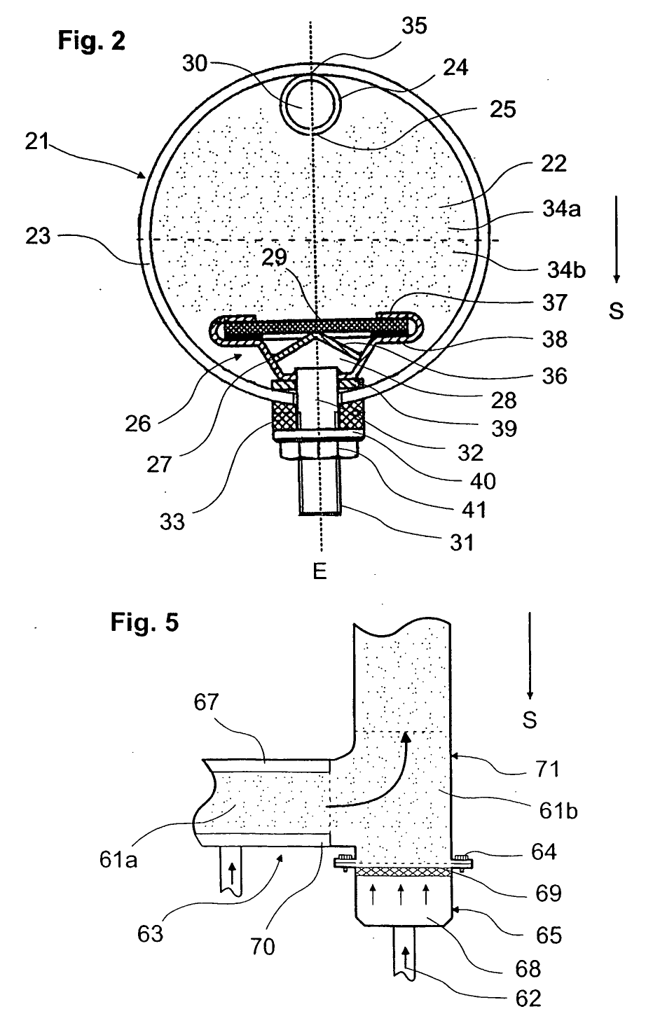

FIG. 2: a cross-section through the conveyor line of a device according to the invention in a second embodiment;

FIG. 3: a longitudinal section through a fluidising device according to the first embodiment;

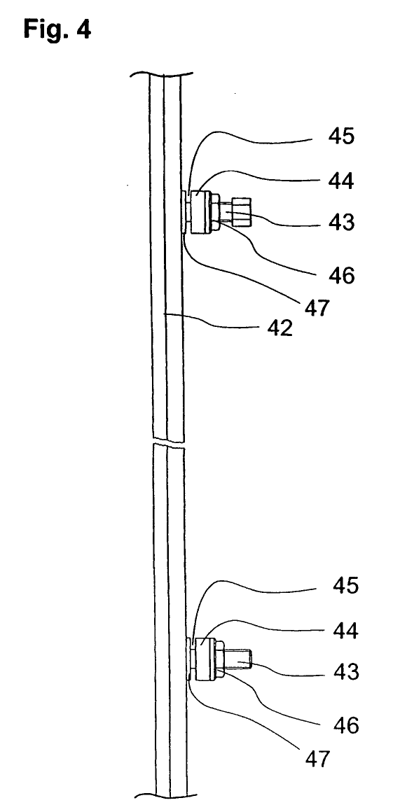

FIG. 4: a side view of a fluidising device according to the first embodiment;

FIG. 5: a cross-section through a pipe elbow in the transition to a vertical gradient with fluidising device arranged therein;

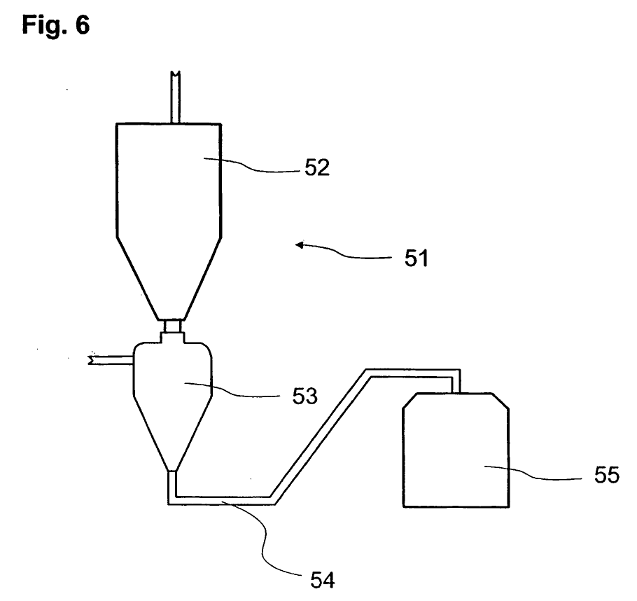

FIG. 6: a diagrammatic view of a pneumatic dense flow conveyor system.

The pneumatic dense flow conveyor system 1 according to the invention in a first embodiment (FIG. 1) contains a conveyor line 3 with a conveyor channel 2 of closed cross-section. The arrow (S) points to the direction of gravity in each case.

In the apex area 15 of the upper channel half 14a is arranged a compressed gas pipeline 4 with a compressed gas channel 18 and with gas passage openings 5. In the floor area of the lower channel half 14b of the conveyor channel 2, i.e. opposite the compressed gas pipeline 4, is arranged the fluidising body 6 of the fluidising device. This contains a fluidising pipe 7 forming a fluidising gas channel 8 with fluidising gas passage openings 9. The fluidising gas passage openings 9 point obliquely downwards i.e. they contain a direction component in the gravity direction so that the gas flowing out of the fluidising gas channel emerges obliquely downwards and no transported material can enter the fluidising channel. The fluidising body 6 furthermore contains a deflection device 10 in the form of a concave (semi-) dish which is arranged such that the emerging fluidising gas is deflected into the conveying channel and forms a direction component against gravity. The deflection device 10 furthermore contains passage openings for passage of the fluidising gas supply line 11.

The fluidising gas emerging from the openings in a multiplicity of fine thin gas streams is scattered during deflection so that the transported material can be fluidised evenly over a broad area by the deflected fluidising gas.

The fluidising device furthermore contains a fluidising gas supply line 11 with a fluidising gas supply channel 12 to supply the pressurised fluidising gas into the fluidising gas channel 8 (FIG. 3). The fluidising gas supply line 11 is fixed by means of a counternut 17 over a washer 16 and associated rubber seal 13 to the conveyor line 3. The fluidising gas supply line 11 is connected e.g. welded to the fluidising pipe 7 such that through the fixing of the fluidising gas supply line 11 to the conveyor line 3 by means of counternuts, the fluidising pipe 7 is also fixed in the conveyor channel 2. As the deflector device 10 is clamped sandwich-like between the walls of the conveyor line 3 and the fluidising pipe 7, this need not necessarily be connected with the fluidising pipe 7 or the conveyor line 3.

The pneumatic dense flow conveyor system 21 according to the invention in a second embodiment (FIG. 2) contains a conveyor line 23 with a conveyor channel 22 of closed cross-section. In the apex area 35 of the upper channel half 34a is arranged a compressed gas pipeline 24 with compressed gas channel 30 and with gas passage openings 25. In the floor area of the lower channel half 34b of the conveyor channel, i.e. opposite the compressed gas pipeline 24, is arranged the fluidising body 26 of the fluidising device. This contains a channel profile 27 forming the fluidising gas channel 28. The fluidising gas passage openings are formed by a textile flat structure 29 which is arranged on the upper area of the fluidising gas channel 28 facing the conveyor channel. The textile flat structure is carried by way of a supporting base 36 so that this forms a flat surface in the manner of a fluidising floor which contains passages or openings for gas circulation in the fluidising gas channel 28. The support floor 36 is formed undulating in cross-section. The textile flat structure is flanged or clamped at the side over the entire length of the channel profile 27, in particular clamped sandwich-like. The textile flat structure can also be glued and/or screwed or riveted. For this the longitudinal side end sections 37 of the channel profile 27 are bent over and pressed clamping onto the textile flat structure 29 lying on a longitudinal shoulder or edge surface 38 of the channel profile 27.

The fluidising gas channel 28 as stated is formed by a channel profile 27 which is closed at the top with a textile flat structure 29. The channel profile 27 is preferably a metal rolled product which is formed into a channel profile in a suitable forming technology such as roll bending. It can however also be an extruded profile.

The fluidising gas in this embodiment flows, fluidising the transported material, against the direction of gravity in a rising movement from the fluidising channel 28 through the textile flat structure 29 into the conveying channel 22.

The fluidising device furthermore contains a fluidising gas supply line 31 with a gas supply channel 32 to supply the pressure-loaded fluidising gas into the fluidising gas channel 28. The fluidising gas supply line 31 is fixed by means of a counternut 41 over a washer 40 and associated rubber seal 33 to the conveyor line 23. The fluidising gas supply line 31 is connected e.g. welded to the fluidising body 27 such that through the fixing of the fluidising gas supply line 31 to the conveyor line 23, the fluidising body 26 is also fixed in the transport channel 22.

A plate-like support element 39, through which the fluidising gas supply line 31 is guided, creates a flat support surface for the channel profile 27 and simultaneously serves as a counterholding element to fix the fluidising gas supply line 31. The support element 39 is formed for example square or rectangular and contains a through hole.

The particle flow in FIGS. 1 and 2 is shown for purely illustrative purposes and does not necessarily correspond to the actual density distribution of the transported material in the dense flow.

The embodiments in FIGS. 1 and 2 are distinguished by simple and hence economic construction. At the same time the construction has proved very robust and durable even in the abrasive environment and is also extremely simple to repair.

FIG. 4 shows a side view of a fluidising gas pipe 42 with fluidising gas supply lines 43 attached thereto according to FIG. 1. To mount the fluidising gas pipe 42 in the conveyor line, the fluidising gas pipe sections are introduced into the conveyor pipe line sections and the fluidising gas supply lines 43 are guided to the outside by way of hole openings in the fluidising gas pipe section. The fluidising gas pipe section is attached to the conveyor line in that the wall of the conveyor line is fixed clamping in the gap 45 between the rubber seal 44 and the deflection element 47 by way of the fixing bolt 46.

In bend sections of the conveyor line preferably an additional fluidising device is arranged. The conveyor line section 63 shown diagrammatically in FIG. 5 has a 90° bend. In the floor area of the bend section element 71, a fluidising device 65 is connected detachably and gas-tight with the bend section element 71 by way of a screwed ring flange connection 64. The fluidising device 65 contains a fluidising chamber 68 and a fluidising gas supply line 62. The gas passage means 69 are formed by a textile flat structure. This separates the fluidising chamber 68 from the transport channel 61b of the bend section and forms a so-called fluidising floor. The supplying transport channel 61a furthermore contains a fluidising device 70 and a compressed gas secondary line 67 according to the invention (indicated only diagrammatically).

The bend section element can be a casting, in particular a metal or plastic casting, which has an opening on the base side for flange attachment of the fluidising device described above. The conveyor line sections are attached by means of couplings for example to the inlet or outlet opening of the bend section element.

FIG. 6 shows a diagrammatic view of a closed pneumatic dense flow conveyor system 51. From a storage silo 52 the transported material is fed into a pressure vessel (sender) 53 and compressed under pressure into the conveyor line 54 and transported to the receiver 55.

1-21. (canceled)

22. Device for pneumatic conveying of a bulk material in the dense flow method, comprising a conveyor line (3) of closed cross-section defining with a conveyor channel (2), a compressed gas secondary line (4) defining with a compressed gas channel (18) and compressed gas passage means (5) for feeding the conveyor channel (2) with a pressurised gas from the compressed gas channel (18), a fluidising device associated with the conveyor line (3), the fluidising device comprises a fluidising body (6) with a fluidising gas channel (8) and fluidising gas passage means (9) for feeding a fluidising gas out of the fluidising gas channel (8) into the conveyor channel (2).

23. Device according to claim 22, wherein the compressed gas passage means (5) includes a gas-permeable separating wall between the compressed gas channel (18) and the conveyor channel (2).

24. Device according to claims 22, wherein the compressed gas secondary line (4) is a compressed gas pipe with gas passage openings guided in an apex area (15) within the conveyor channel (2).

25. Device according to claim 22, wherein the compressed gas passage means (5) comprise at least one of holes, slots, perforations and pores in the wall of the compressed gas secondary line (4).

26. Device according to claim 22, wherein the fluidising body (6) is arranged in a base area within the conveying channel (2).

27. Device according to claim 22, wherein the fluidising gas passage means (9) comprise a gas-permeable separating wall between the fluidising gas channel (8) and the conveying channel (2).

28. Device according to claim 22, wherein the fluidising gas passage means (9) comprise a wall of the fluidising gas channel (8) fitted with at least one of holes, perforations and pores.

29. Device according to claim 22, wherein the fluidising device comprises deflection means (10) for deflecting the fluidising gas emerging through the fluidising gas passage means (9) into the conveying channel (2) wherein the deflection means (10) is arranged such that the deflected fluidising gas has a direction component against the gravity acting on the transported material particles.

30. Device according to claim 29, wherein the deflection means (10) comprises deflection elements (1) comprises flat or (2) concave deflection sheets or plates, or are formed by a wall of the conveying channel (2).

31. Device according to claim 22, wherein the fluidising gas passage openings are aligned such that the fluidising gas emerging from the fluidising gas channel (8) into the conveying channel (2) has a direction component pointing in the gravity direction.

32. Device according to claim 22, wherein the fluidising body (6) comprises a fluidising gas pipe (7) forming a fluidising gas channel (8) and the fluidising gas passage means (9) comprises openings in the wall of the fluidising gas pipe (7).

33. Device according to claim 22, wherein the fluidising gas passage means (29) comprise a textile flat structure.

34. Device according to claim 31, wherein the textile flat structure is arranged such that the fluidising gas emerging from the fluidising gas channel (28) into the conveying channel (22) has a direction component pointing against the gravity direction.

35. Device according to claim 34, wherein the conveyor line (23) is composed of several conveyor line sections and the fluidising gas channel (28) forms a closed hollow cavity, which is closed at both ends, with openings for the fluidising gas supply and the fluidising gas passage.

36. Device according to claim 35, wherein a fluidising body is associated with each conveyor line section and the fluidising bodies of the individual conveyor line sections are not directly connected together.

37. Device according to claim 35, wherein the fluidising body of a conveyor line section is connected by way of the fluidising gas supply line system with the fluidising body of at least an adjacent conveyor line section.

38. Device according to claim 35, wherein the fluidising body is the same length as or shorter than the conveyor line sections and preferably does not protrude beyond the ends of the conveyor line sections.

39. Device according to claim 35, wherein allocated to each conveyor line section are one, two or more fluidising gas supply lines (11) penetrating the conveyor line and opening in the fluidising gas channel.

40. Method for conveying a bulk material employing the device according to claim 22, wherein the transported material is pressurised in a pressure vessel (59), fed from the pressure vessel into the conveyor line (54), loosened by means of the compressed gas fed from the compressed gas secondary line (4) into the conveying channel (2) from above, and fluidised by the fluidising gas fed from the fluidising gas channel (8) in the floor into the conveying channel (2).
